(19) United States
(12) Patent Application Publication
(10) Pub. No.: US 2025/0089919 A1
(43) Pub. Date: Mar. 20, 2025

(54) PLATE DOLLY

(71) Applicant: SHAMAR T. STEWART, HUNTSVILLE, TX (US)

(72) Inventor: SHAMAR T. STEWART, HUNTSVILLE, TX (US)

(21) Appl. No.: 18/886,975

(22) Filed: Sep. 16, 2024

Related U.S. Application Data
(60) Provisional application No. 63/582,599, filed on Sep. 14, 2023.

(51) Int. Cl. A47G 19/08; F16M 11/42

(52) U.S. Cl. CPC A47G 19/08; F16M 11/42

(57) ABSTRACT

A plate dolly assembly includes a body, a plurality of casters, and a surface treatment. The plate dolly assembly is configured to support the resting and transportation of a container of various sizes. The casters are configured to glide smoothly on a surface to make moving the container simple and easy. The caster are located along a lower surface of the body. The casters may rotate 360 degrees so that the dolly will move in any direction with ease. The surface treatment is located along an upper surface of the body and configured to stabilize and secure the container thereon. A central void space is located in the body for acceptance of a portion of the container.

### CROSS REFERENCE TO RELATED APPLICATIONS

This application claims the benefit of an earlier filing date and right of priority to U.S. Provisional Application No. 63/582,599, filed 14 Sep. 2023, the contents of which is incorporated by reference herein in its entirety.

### BACKGROUND OF THE INVENTION

### 1. Field of the Invention

The present application relates to a dolly, and more particularly to a transportable dolly for use with food containers.

### 2. Description of Related Art

During the Industrial Revolution, family dinners became less common as people's work schedules changed, and individuals were more likely to eat on their own. However, in the mid-twentieth century, there was a renewed emphasis on family dinners, particularly in the United States. Sociologists and psychologists began to study the effects of family dinners on child development and found that regular family dinners had numerous benefits, including improved academic performance and reduced risky behavior. Today, while the tradition of family dinners continues to evolve, it remains an essential aspect of family life in many cultures. Despite the challenges of modern life, many families still prioritize coming together at the dinner table, recognizing its importance in fostering strong relationships and a sense of community.

While family dinners are an important tradition in many cultures, they can also present certain challenges. One of the primary issues is the placement of dishes on the table, which can make it difficult for individuals to access the food they want without having to ask others to pass it. This can lead to spills, loss of food, and even injuries or broken dishes, particularly when large or heavy containers are involved. Additionally, the process of passing dishes can be awkward and uncomfortable, particularly when hot or messy foods are involved.

Another issue with family dinners is that the preparation and serving of food can be time-consuming and stressful, particularly for the person responsible for cooking the meal. This can take away from the enjoyment of the dinner itself, making it a source of tension and frustration rather than a time to relax and connect with loved ones. Overall, these challenges can detract from the overall experience of family dinners, making them less enjoyable and more stressful than they need to be.

Although strides have been made, shortcomings remain. It is desired that an assembly be provided to allow for a simpler and less stressful method of transporting food about a table during a meal.

### BRIEF SUMMARY OF THE INVENTION

It is an object of the present application to provide a plate dolly assembly designed to fit under plates and containers of various sizes. The assembly is configured to include a plurality of casters to glide smoothly on any flat surface, such as a table or countertop. The casters may rotate 360 degrees so that the dolly will move in any direction with ease.

Each assembly comes equipped with a non-skid surface on the top where contact is made with the food container. The non-skid surface is heat resistant to assure the user that serving dishes with hot food will not affect the dolly. The assembly is constructed with high quality and high impact plastic that is both durable and attractive and is available in colors denoting the different sizes.

It is an object of the present assembly to eliminate the lifting of containers of food that include plates, bowls, casserole dishes, and many other styles of cooking containers and dinnerware. Large full platers that contain large dishes such as turkey, ham, beef roast, and other dishes can be moved about the table or counter with the ease which the assembly offers the user.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a plate dolly assembly according to an embodiment of the present application located under a pot.

FIG. 2 is a partially exploded view of the assembly of FIG. 1.

FIG. 3 is a secondary partially exploded view of the assembly of FIG. 1.

FIG. 4 is an enlarged view of the plate dolly assembly of FIG. 3.

FIG. 5 is an upper perspective view of the assembly of FIG. 1.

FIG. 6 is a lower perspective view of the assembly of FIG. 5.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The plate dolly assembly is a practical and innovative product that makes it easy to move plates, bowls, and platters of food across a flat surface, such as a table or countertop. Its design features a slip-resistant ring that is glazed with a non-slip coating and smooth caster wheels attached to the bottom. The smooth caster wheels or ball caster wheels enable the ring to be pushed freely in any direction, eliminating the need to lift plates of food to pass to another person.

The plate dolly assembly's non-slip coating keeps the serving dish securely on the ring, preventing any unwanted sliding or movement. To accommodate various sizes of serving dishes, the plate dolly assembly is available in different diameters of rings or as an adjustable ring. It's simple but effective design is perfect for families or any social event where food needs to be passed around the table. The plate dolly assembly can help make family dinners more enjoyable, safer, and more convenient for everyone involved.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

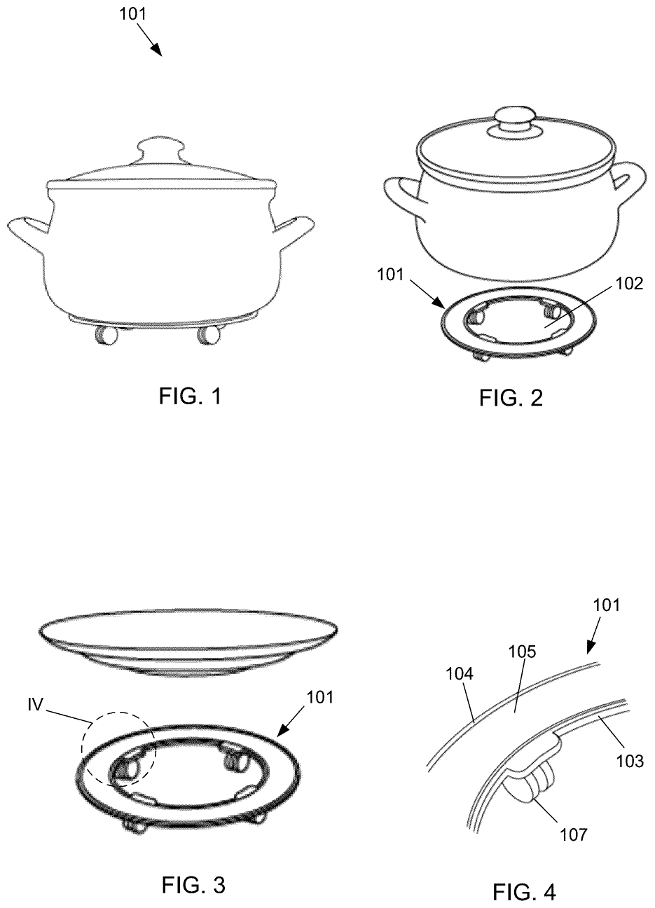

Referring now to FIGS. 1 and 2 in the drawings, a side view of a plate dolly assembly 101 is illustrated. Assembly 101 is designed to fit under plates and containers of various sizes. Assembly 101 is configured to capture the plates, containers, and pots (i.e. container 99) of various sizes within a defined central void area and to permit its selective transportation about a surface. In one embodiment, assembly 101 may feature a plurality of wheels, such as a set of four casters, for each dimension of the assembly. The container 99 may be removed at any time as seen in FIG. 2. In FIG. 2, the container 99 is removed away from assembly 101 to more clearly show a depiction of assembly 101.

It is understood that assembly 101 is configured to adapt to the contour of container 99, such that container 99 may rest along an upper surface of its body and/or within a portion of the void area. Although the body appears to be planar along its upper surface, it is understood that the body of assembly 101 may have a slope or non planar contour.

Referring now also to FIGS. 3 and 4 in the drawings. In FIG. 3, assembly 101 is shown as a partially exploded view. Assembly 101 is shown with a plate above it. This is useful to help show that more than a pot from FIGS. 1 and 2 may be used with assembly 101. Plates, bowls, and other trays and containers, container 99, may be used with assembly 101. For purposes herein, the term “container” will be used to refer to any of the items listed above, or those of similar nature whether for food or not, for use with assembly 101.

In FIG. 4 is shown an enlarged view of assembly 101. Assembly 101 includes a body 103 having an upper surface treatment 105. An example of a suitable surface treatment is a non-skid surface on an upper surface 104 of the body 103. Along the upper surface, the containers contact a portion of body 103. The non-skid surface is heat resistant to assure the user that serving dishes with hot food will not affect the dolly. Assembly 101 is constructed with high quality and high impact plastic that is both durable and attractive and is available in colors denoting the different sizes.

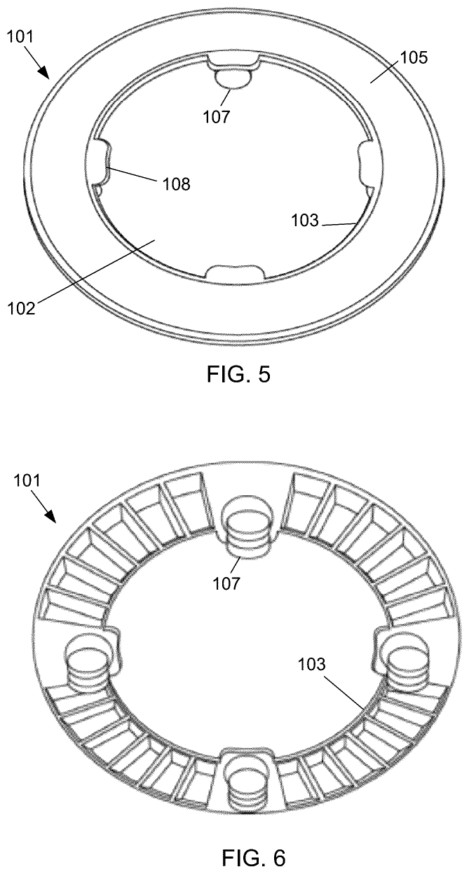

Referring now also to FIGS. 5 and 6 in the drawings, views of assembly 101 are provided. In FIG. 5, an upper perspective view of assembly 101 is shown. Body 103 is shown in the form of a circle having a central void space therethrough. It is understood that the form and shape of assembly 101 is not herein limited to that which is depicted but is free to assume other forms and shapes as desired. Void space 102 is ideally similar in shape to that of body 103 but may also include internal tabs 108 which act to extend inward within void space 102 and effectually increase upper surface 104. Tabs 108 may act to engage any feet or miscellaneous contouring beneath container 99 to help add stability and minimize rotation of container 99 within assembly 101.

Additionally, surface treatment 105 is configured to be applied to any portion of body 103, including any portion of the upper surface of body 103. Other recesses, protruding, elevated surfaces, tabs, or dissimilar materials may be used to assist in the purposes stated herein.

As seen in FIG. 6, a lower perspective view is shown of assembly 101. As noted above, the size, shape, and form may be varied. Body 103 is shown to be produced of high-strength nylon polymer. Body 103 includes a ribbed underside which serves to strengthen the design and promote efficiency in manufacturing through evenly spaced material distribution. The design of the assembly 101 is suitable for injection molding manufacturing. Consisting of even thickness throughout and having a one-piece structure makes for an efficient manufacturing and shipping process. It should be known that assembly 101 may be configured to include an adjustable version wherein the size of body 103 may be adjusted to permit different sized containers to be held.

Assembly 101 has a primary function to provide a smooth and effortless way to move containers across a flat surface like a table or countertop. The castors 107 are configured to permit rotation for 360 degrees, allowing for free range of motion across any flat surface, are procured from reputable suppliers worldwide and are assembled by inserting the castor stud into pre-molded holes at 90 degrees spacing.

By creating an environment where plates and containers of food can be moved about with ease, assembly 101 can reduce some of the labor involved in moving dishes. A heavy plate no longer has to be lifted to be moved, and the assembly will also increase the safety and efficiency of the entire meal. The assembly is an improvement in the serving of family meals that everyone who serves families or other types of meals will find exceptionally valuable.

Many unique and novel features are present in the current invention such as the following. Assembly 101 is constructed with high-quality and high-impact plastic, making it durable and attractive. It also features a non-skid surface on top that is heat-resistant, ensuring that hot food will not damage the dolly. The assembly is configured to glide smoothly on any flat surface, such as a table or countertop. The casters rotate 360 degrees so that the dolly will move in any direction with ease.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A plate dolly, comprising:
a body having a central void area;
a plurality of casters in communication with a lower surface of the body; and
a surface treatment on an upper surface of the body.

2. The dolly of claim 1, wherein the plurality of casters are configured to rotate 360 degrees.

3. The dolly of claim 1, wherein the surface treatment is a non-skid surface.

4. The dolly of claim 3, wherein the surface treatment extends around the void area.

5. The dolly of claim 4, wherein the body includes a tab extending into the central void area.

6. The dolly of claim 1, wherein the surface treatment is heat resistant.

7. The dolly of claim 1, wherein the surface treatment includes at least one of a recess, protrusion, or elevated surface.

8. The dolly of claim 1, wherein the surface treatment is made of a dissimilar material to that of the body.

9. The dolly of claim 1, wherein the surface treatment extends around the void area.

10. The dolly of claim 1, wherein the body includes a tab extending into the central void area.
